(19) United States
(12) Patent Application Publication
(10) Pub. No.: US 2010/0135187 A1
(43) Pub. Date: Jun. 3, 2010

(54) SYSTEM AND METHOD FOR CONTROLLING NETWORK CONFIGURATION FOR MOVING OBJECT

(75) Inventor: Gwang Hoon Kwark, Busan (KR)

Correspondence Address: LOWE HAUPTMAN HAM & BERNER, LLP, 1700 DIAGONAL ROAD, SUITE 300, ALEXANDRIA, VA, 22314, US

(73) Assignee: Dong-A University Research Foundation for Industry Academy Cooperatioin, Busan (KR)

(21) Appl. No.: 12/420,341

(22) Filed: Apr. 8, 2009

(30) Foreign Application Priority Data
Dec. 1, 2008 (KR) 10-2008-0120758
Mar. 24, 2009 (KR) 10-2009-0024977

(51) Int. Cl. H04Q 5/22; H04L 12/28

(52) U.S. Cl. 370/254; 340/10.1

(57) ABSTRACT

Provided are a system and a method for controlling a network configuration for a moving object. A monitoring device attached to the moving object, that is, a container loading a cargo, recognizes loading and moving circumstances of the container, construct a network with other containers according to the circumstances and performs connection/disconnection of the container to/from a network and maintenance of the connection until the container departs the origin and arrives at a destination through overland transportation and marine transportation. Accordingly, the state of the container is monitored, monitoring information is transmitted to a container administrator and the power of the monitoring device which constructs an optimized network with other monitoring devices according to container circumstances is saved.

### BACKGROUND OF THE INVENTION

1. Field of the Invention

The present invention relates to a technique of monitoring the movement of a moving object to manage a network configuration for the moving object, and more particularly, to a system and a method for controlling a network configuration for a moving object loading a cargo, which control connection of the moving object, that is, a container, to a network, maintenance of the connection or disconnection of the container from the network according to moving circumstances of the container.

2. Description of the Related Art

A conventional container control process includes loading a cargo in a container at the origin, overland transporting the container to a container yard or a container terminal using a transportation vehicle, passing the an entrance gate of the container terminal, unloading the container to the container terminal, shipping the container, transporting the container to a destination port, unloading the container at the destination port, passing an exit gate of a container terminal at the destination port, overland transporting the container to a destination, and unloading the cargo from the container, which are carried out under the control of a cargo sender, a cargo recipient and an administrator.

When people personally control a container as described above, as described above, lots of people are required and it is difficult to control a container being transported.

As wireless communication technologies such as RFID/USM for improving convenience and security attract attention with the advent of a ubiquitous society, container control is carried out in such a manner that specific sensors are attached to a container and the state of the container is confirmed using information received from the sensors.

To control the container through container information received through the specific sensors, as described above, a wireless communication network capable of transmitting the container information in real time is required. However, a conventional method for controlling a wireless communication network configuration does not consider temporal and spatial circumstantial variations of nodes constructing the network, and thus a network configuration control message should be transmitted and received excessively frequently. This wastes power of a monitoring device attached to the container and requirements of the monitoring device which requires battery power for a long time cannot be satisfied.

### SUMMARY OF THE INVENTION

The present invention provides a system and a method for controlling a network configuration for a moving object, which vary a signaling period according to moving circumstances of the moving object to control connection of the moving object to a network, maintenance of the connection and disconnection of the moving object from the network.

According to an aspect of the present invention, there is provided a system for controlling a network configuration for moving objects, which comprises a plurality of moving objects transported by a specific transportation means and a monitoring device which includes a short-distance communication tag and an operation sensor, is attached to a moving object to construct a network with the transportation means transporting the moving object overland and constructs a network with other monitoring devices attached to other moving objects according to whether the other moving objects are moved when the moving object is not being transported overland.

According to another aspect of the present invention, there is provided a monitoring device for controlling a network configuration for a moving object, which comprises a communication unit communicating with an Internet gateway, an operation sensor sensing whether the moving object is moved, a short-distance communication tag sensing whether the moving object passes through a first point or a second point, and a controller constructing a network with a first transportation means transporting the moving object overland and constructing a network with other monitoring devices attached to multiple other moving objects according to whether the moving object is moved when the moving object is not being transported overland.

The controller may construct a 1:1 network with the first transportation means, activate the operation sensor when a signal representing that the moving object passes through the first point is received from the short-distance communication tag and disconnect the moving object from the 1:1 network when the operation sensor senses the movement of the moving object.

The controller may connect the moving object o a dynamic network composed of multiple other moving objects when the moving object is unloaded and the operation sensor senses that the movement of the moving object is stopped.

After the moving object is unloaded and connected to the dynamic network, the controller may disconnect the moving object from the dynamic network and connect the moving object to a new dynamic network when a dynamic network reconstruction signal is received from an external device through the communication unit.

The controller may disconnect the moving object from the dynamic network when the operation sensor senses the movement of the moving object after the moving object is connected to the dynamic network, repeat connection/disconnection of the moving object to/from a dynamic network until a departure signal is received from an external device through the communication unit, inactivate the operation sensor and connect the moving object to a static network composed of multiple other monitoring devices when the departure signal is received.

The controller may activate the operation sensor when an unloading start signal is received from an external device through the communication unit after the moving object is connected to the static network, disconnect the moving object from the static network when the operation sensor senses the movement of the moving object, and connect the moving object to a dynamic network composed of multiple other monitoring devices when the operation sensor senses that the moving object is stopped.

The controller may disconnect the moving object from the dynamic network when the movement of the moving object is sensed after the moving object is connected to the dynamic network, repeat connection/disconnection of the moving object to/from a dynamic network until the moving object passes through the second point, inactivate the operation sensor and then construct a 1:1 network with the first transportation means when a signal representing that the moving object passes through the second point is received.

The operation sensor may sense an impact applied to the moving object and provide information on the impact to the controller in order to confirm whether the moving object is damaged.

The monitoring may further comprise a storage unit storing the information on the impact applied to the moving object, provided by the operation sensor.

The system may further comprise a state sensor sensing monitoring information on the moving object.

According to another aspect of the present invention, there is provided a method for controlling a network configuration for a moving object, comprising a first network constructing step in which a monitoring device attached to the moving object constructs a 1:1 network with a first transportation means for transporting the moving object overland, a second network constructing step in which the monitoring device disconnects the moving object from the 1:1 network when the movement of the moving object is detected after the moving object passes through a first point and connects the moving object to a dynamic network composed of multiple other moving objects when it is detected that the movement of the moving object is stopped, a third network constructing step in which the monitoring device disconnects the moving object from the dynamic network when the movement of the moving object is detected and connects the moving object to a static network composed of multiple other monitoring devices when a departure signal is received from an external device, a fourth network constructing step in which the monitoring device disconnects the moving object from the static network when an unloading start signal is received from an external device and the movement of the moving object is detected and connects the moving object to a dynamic network composed of multiple other monitoring devices when it is detected that the movement of the moving object is stopped, and a fifth network constructing step in which the monitoring device disconnects the moving object from the dynamic network when the movement of the moving object is detected and constructs a 1:1 network with the first transportation means when it is detected that the moving object passes through a second point.

The second network constructing step may comprise a step in which the monitoring device activates an operation sensor which senses the movement of the moving object when it is detected that the moving object passes through the first point and senses an impact applied to the moving object in order to confirm whether the moving object is damaged.

The method may further comprise a step in which the monitoring device disconnects the moving object from the dynamic network and connects the moving object to a new dynamic network when a dynamic network reconstruction signal is received from an external device after the moving object is unloaded, stopped and connected to the dynamic network after the second or fourth network constructing step.

In the third network constructing step, the monitoring device may disconnect the moving object from the dynamic network when the movement of the moving object is sensed after the moving object is unloaded, stopped and connected to the dynamic network, repeat connection/disconnection of the moving object to/from a dynamic network until the departure signal is received, and inactivate the activated operation sensor when the departure signal is received.

In the fourth network constructing step, the monitoring device may activate the inactivated operation sensor when the unloading start signal is received from the external device.

In the fifth network constructing step, the monitoring device may disconnect the moving object from the dynamic network constructed when the moving object loaded in the first transportation means is unloaded from the first transportation means, repeat connection/disconnection of the moving object to/from a dynamic network until the moving object passes through the second point, and inactivate the activated operation sensor when it is detected that the moving object passes through the second point.

The method may further comprise a step of activating a state sensor sensing monitoring information on the moving object when the monitoring device is activated before the first network constructing step.

As described above, the present invention varies a signaling period according to moving circumstances of the moving object to control connection of the moving object to a network, maintenance of the connection and disconnection of the moving object from the network, and thus power of the monitoring device attached to the moving object can be saved.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a network system for a moving object being overland transported according to an embodiment of the present invention;

FIG. 2 illustrates a configuration of a network system for a plurality of moving objects according to an embodiment of the present invention;

FIG. 3 is a block diagram of a monitoring device illustrated in FIG. 1;

FIG. 4 is a flowchart illustrating a process of controlling a network configuration for a moving object according to an embodiment of the present invention;

FIG. 5 is a flowchart illustrating an operation of constructing and controlling a dynamic network for a moving object, which is illustrated in FIG. 4, in more detail;

FIG. 6 illustrates a transportation flow of a moving object based on control of network configuration for the moving object according to an embodiment of the present invention; and

FIG. 7 illustrates a dynamic/static network configuration model for moving objects according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

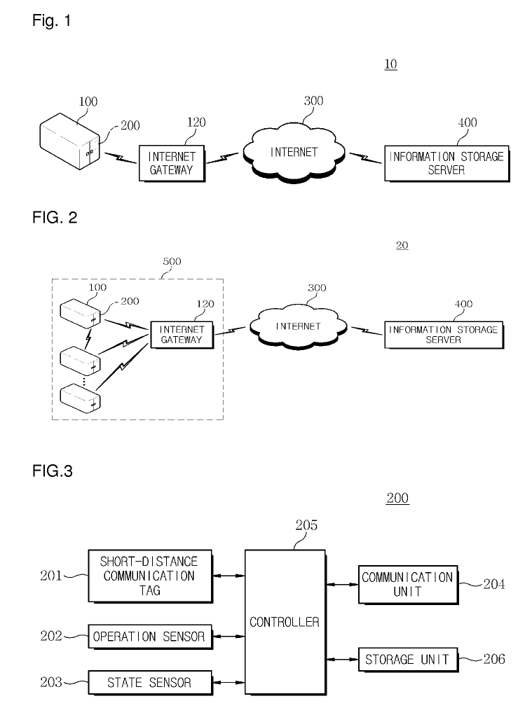

FIG. 1 illustrates a configuration of a network system for a moving object that is being transported overland according to an embodiment of the present invention, FIG. 2 illustrates a configuration of a network system for a plurality of moving objects according to an embodiment of the present invention, and FIG. 3 is a block diagram of a monitoring device illustrated in FIG. 1.

Referring to FIGS. 1, 2 and 3, an object monitoring system 10 for a moving object that is being transported overland according to an embodiment of the present invention includes a container 100, an Internet gateway 120, the Internet 300, and an information storage server 400. A network system 20 for a plurality of moving objects according to an embodiment of the present invention includes a plurality of containers 100, the Internet gateway 120, the Internet 300 and the information storage server 400.

The container 100 is a moving object that can be moved by a transportation means such as a vehicle, a ship, etc. correspond to a loading container and store an arbitrary type of cargo or an arbitrary number of cargos.

While the loading container means a cargo container including a railroad covered card, a machine, a marine container and a road container, the present invention is not limited thereto.

The container 100 has a monitoring device 200 including a short-distance communication tag 201, an operation sensor 202, a state sensor 203, a communication unit 204, a controller 205, and a storage unit 206, as illustrated in FIG. 3. Although the short-distance communication tag 201, the operation sensor 202 and the state sensor 203 are included in the monitoring device 200 in the current embodiment of the present invention, the present invention is not limited thereto and the operation sensor 202 and the state sensor 203 may be attached to the container 100.

The short-distance communication tag 201 may be an RFID (Radio Frequency Identification) tag or an OBU (On Board Unit) of DSRC (Dedicated Short Range Communication). The short-distance communication tag 201 confirms whether the container 201 passes through a first point and a second point (referred to as a first gate and a second gate hereinafter) and provides the confirmation result to the controller 205.

Here, the first gate corresponds to an entrance gate of a container terminal through which the container 100 must pass in order to enter the container terminal to be shipped and the second gate corresponds to an exit gate of a container terminal through which the container must pass after unloaded in order to exit the container terminal to be transported overland to a destination. That is, the first and second gates mean gateways which discriminate an environment in which the container 100 is loaded and an environment in which the container is transported overland from each other. Furthermore, a reader capable of reading the short-distance communication tag 201, that is, an RFID reader or an RSU (Road Side Unit) of DSRC, may be attached to each of the first and second gates.

The operation sensor 202 provides collected information to the controller 205. The operation sensor 202 is activated/inactivated under the control of the controller 205. The operation sensor 202 senses whether the container 100 is moved in an activated state and provides the sensing result to the controller 205. Furthermore, the operation sensor 202 may store the level of impact that requires to be recorded (impact level higher than a threshold value) among impacts applied to the container 100 in the storage unit 206 through the controller 105 or transmit the level of impact to the information storage server 400 through the communication unit 204. The level of impact is used to sense damage of goods caused by impact later.

The state sensor 203 collects monitoring information such as a temperature, a humidity, gases, salinity and opening/closing of a door of the container 100 and provides the collected monitoring information to the controller 205. The state sensor 203 is activated/inactivated under the control of the controller 205.

The communication unit 204 transmits information on the state of the container 100, collected through the short-distance communication tag 201, the operation sensor 202 and the state sensor 203 to the information storage server 400 through the Internet gateway 120 and the Internet 300 under the control of the controller 205.

When a cargo is loaded in the container 100 and a sender or an administrator selects power activation of the monitoring device 200 to turn on the power of the monitoring device 200, the communication unit 204 attempts to connect a communication path with the Internet 300 and maintains the connection of the communication path under the control of the controller 205 until the cargo loaded in the container 100 is unloaded by a recipient. This operation may be performed through the Internet gateway mounted in a container transporting means, that is, a vehicle or a ship, or the Internet gateway mounted in a container terminal where the container is unloaded.

More specifically, the communication unit 204 constructs a 1:1 network with the Internet gateway 120 before the container 100 loading the cargo is overland transported to the first gate or after the container 100 exits the second gate. The communication unit 204 may transmit monitoring information on the container 100 being overland transported to the information storage server 400 and receive administration information that requests the monitoring information on the container 100 from the information storage server 400 through wireless Internet such as CDMA/GSM when the 1:1 network is constructed. FIG. 1 illustrates that the communication unit 204 constructs the 1:1 network with the Internet gateway 120.

Furthermore, the communication unit 204 connects to a dynamic/static network composed of monitoring devices attached to other containers to construct the dynamic/static network with the monitoring devices for a period from when the vehicle loading the container 100 enters the first gate to when the vehicle exits the second gate. Here, the communication unit 204 can construct the dynamic/static network by using the Internet gateway 204 mounted in a ship/container terminal as a sink node. FIG. 2 illustrates that the communication unit 204 constructs the dynamic/static network 500 with monitoring devices attached to other containers.

The controller 205 is activated when power is applied to the monitoring device 200 and controls activation/inactivation of the operation sensor 202 according to moving circumstances of the container 100. Furthermore, the controller 205 controls the communication unit 204 to connect/disconnect the container 100 to/from a 1:1 network, to connect/disconnect the container 100 to/from a dynamic network and to connect/disconnect the container 100 to/from a static network. The controller 205 determines that an impact is applied to the container 100 from the inside/output of the container 100 when the level of impact applied to the container 100, which is provided by the operation sensor 202, is higher than the level of impact generated in the case of a normal operation of the container 100, and transmits information on the level of impact to the information storage server 400 through the Internet gateway 120. This is performed in order to confirm whether or not the container 100 is damaged later.

More specifically, the controller 205 controls the communication unit 204 to construct a 1:1 network with the Internet gateway 120 mounted in the vehicle for transporting the container 100 to the container terminal and activates the state sensor 203. Here, the 1:1 network can be constructed only by connecting the monitoring device 200 to the Internet gateway 120 mounted in the vehicle, and thus a relatively simple communication protocol is employed, transmission/reception of a signaling message for maintaining the network configuration and processing of the signaling message are simplified and a signaling message transmitting/receiving period increases as compared to the case of a dynamic/static network configuration.

The controller 205 collects monitoring information such as the temperature, humidity, gases and salinity of the inside of the container 100 and opening/closing of a container door, sensed by the state sensor 203, and transmits the collected monitoring information to the information storage server 400 through the Internet gateway 120. Here, the state sensor 203 is activated while power is supplied to the monitoring device 200 and continuously transmits the monitoring information on the container 100 to the information storage server 400. If the monitoring information could not be transmitted, the controller 205 stores the monitoring information in the storage unit 204 and controls the communication unit 204 to transmit the stored monitoring information to the information storage server 400 when the monitoring information can be transmitted.

Subsequently, the controller 205 activates the operation sensor 202 to sense whether the container 100 is moved when receiving a first gate passing signal which represents that the container 100 enters the container terminal from the short-distance communication tag 201. The controller 205 controls the communication unit 204 to disconnect the container 100 from the 1:1 network when receiving a signal that represents the movement of the container 100 from the operation sensor 202.

Furthermore, the controller 205 controls the communication unit 204 to repeat connection to and disconnection from a dynamic network based on whether the container 100 is moved, which is sensed by the operation sensor 202, until the container 100 is shipped and a departure signal is applied to the controller 205.

The container 100 is located in the container terminal before shipped, in general, and the location of the container 100 may be frequency changed. This causes frequent movement of the container 100 and frequent connection/disconnection to/from a network to result in a frequent variation in the topology of a network composed of other monitoring devices and an increase in the number of signaling messages transmitted/received between containers. Accordingly, the controller 205 connects the container 100 to a dynamic network composed of other monitoring devices.

Upon the construction of the dynamic network, the controller 205 may store the monitoring information provided by the state sensor 103 or control the communication unit 204 to transmit the monitoring information to the information storage server 400. Furthermore, the controller 205 may receive administration information that requests the monitoring information of the container 100 from the information storage server 400 through the communication unit 204.

When the controller 205 receives a network reconstruction signal from an external device through the Internet gateway 120 mounted in a lighting tower of the container terminal and the communication unit 204 while the container 100 is connected to the dynamic network, the controller 205 controls the communication unit 204 to disconnect the container 100 from the dynamic network and reconstruct a network optimized according to location circumstances of the container 100. Containers are piled up in a stack structure, in general, and thus a newly unloaded container may disturb an air link of the existing containers constructing a network in many cases. Accordingly, the controller 205 controls the communication unit 204 to reconstruct a network optimized for the current location of the container 100 in such a manner that containers located in close proximity to the Internet gateway 120 corresponding to the sink node become parent nodes and containers located distant from the Internet gateway 120 become child nodes.

While the network configuration control with respect to a single monitoring device included in a single container is explained in the current embodiment of the present invention, it is desirable that all the monitoring devices constructing the current network are disconnected from the current network if the network reconstruction signal is received.

When the operation sensor 202 senses the movement of the container 100 after the dynamic network is constructed, the controller 205 controls the communication unit 204 to disconnect the container 100 from the dynamic network.

Subsequently, when the controller 205 receives a departure signal from the Internet gateway 120 mounted in a control center of a ship in which containers are loaded, the controller 205 inactivates the operation sensor 202 and controls the communication unit 204 to connect to a static network composed of other containers while the containers are shipped. Here, since the container 100 loaded in the ship is hardly moved until the container 100 is unloaded from the ship, there is a low possibility that the container 100 is disconnected from the current network and connected to a new network, and thus it is desirable to continuously maintain the current network. Accordingly, the controller 205 constructs a static network and the period of a signal transmitted/received to/from other containers when the network is constructed or in the constructed network increases. Therefore, the power required to construct a static network is lower than the power required to construct a dynamic network.

The controller 205 activates the operation sensor 200 when receiving a container unloading start message through the Internet gateway 120 mounted in the control center of the ship or the internet gateway 120 installed in facilities such as a lighting tower of the container terminal after the static network is constructed. The controller 205 disconnects the container 100 from the static network to which the container 100 is connected when the container 100 is shipped when the activated operation sensor 202 senses the movement of the container 100 and connects the container 100 to a dynamic network composed of other monitoring devices to construct the dynamic network with the other monitoring devices when the operation sensor 202 senses that the movement of the container 100 is stopped. Here, the dynamic network is constructed because the container 100 may be frequently moved and frequently connected/disconnected to/from a network until the container 100 is unloaded from the ship to a container terminal and passes through the second gate. Construction of the dynamic network is performed similarly to the construction of the dynamic network, which is carried out for the period from when the container 100 passes through the first gate to when the departure signal is received, so that detailed explanation thereof is omitted.

When the container 100 is unloaded from the ship to the container terminal and then loaded into a vehicle to be overland transported to a destination, the controller 205 inactivates the operation sensor 202 when receiving a second gate passing signal that represents that the container 100 exits the container terminal from the short-distance communication tag 201. The controller 205 controls the communication unit 204 to construct a 1:1 network with the Internet gateway 120 mounted in the vehicle for transporting the container 100, as illustrated in FIG. 1.

The controller 205 is inactivated as the monitoring device 200 is powered off after the container 100 arrives at the destination.

The storage unit 206 stores the monitoring information on the container 100, sensed through the state sensor 203, under the control of the controller 205. Furthermore, the storage unit 206 may store a program capable of controlling the monitoring device 200 according to the controller 205.

While an input unit and an output unit of the monitoring device 200 are not described in the current embodiment of the present invention, the input unit and the output unit may be added in order to smoothly control the monitoring device 200. In this case, the input unit may be configured in the form of an input button capable of providing a signal that represents loading/unloading of goods into/from the container 100 to the controller 205 and the output unit may be configured in the form of an LED (Light emitting Diode) that indicates whether the power of the monitoring device 200 is activated or inactivated.

The Internet 300 provides a communication path between the monitoring device 200 and the information storage server 400.

The information storage server 400 collects monitoring information on a plurality of containers, transmitted from a plurality of Internet gateway or a plurality of monitoring devices, and stores the collected monitoring information.

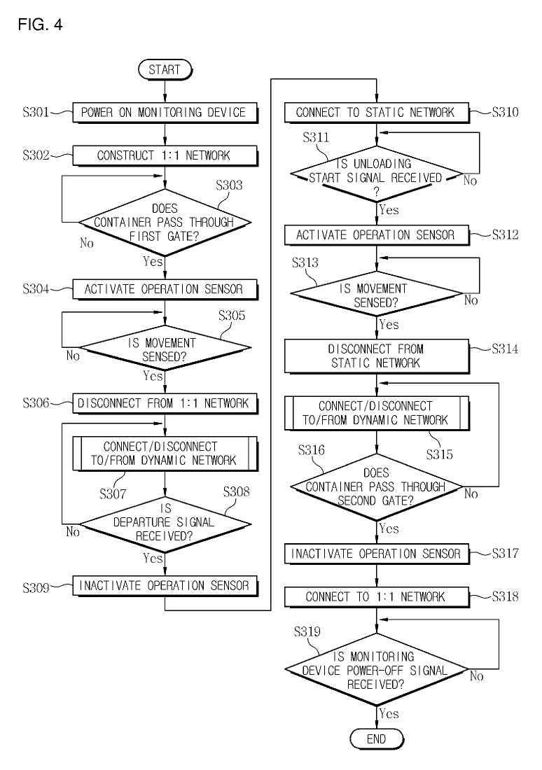

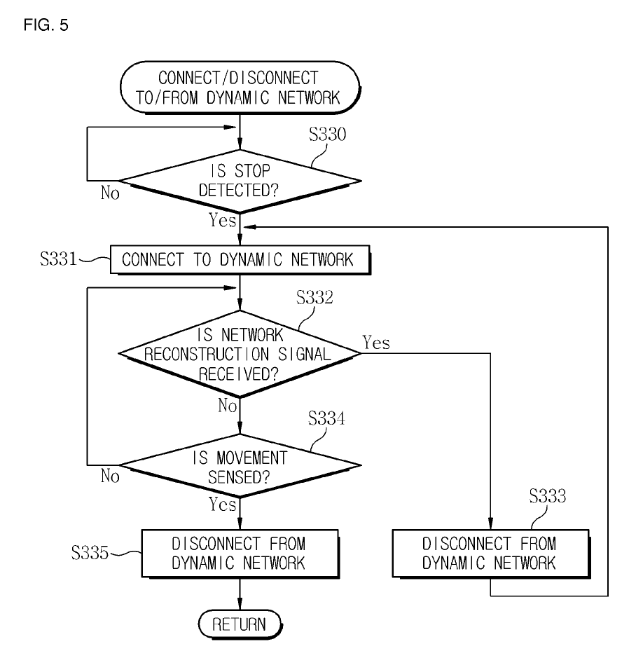

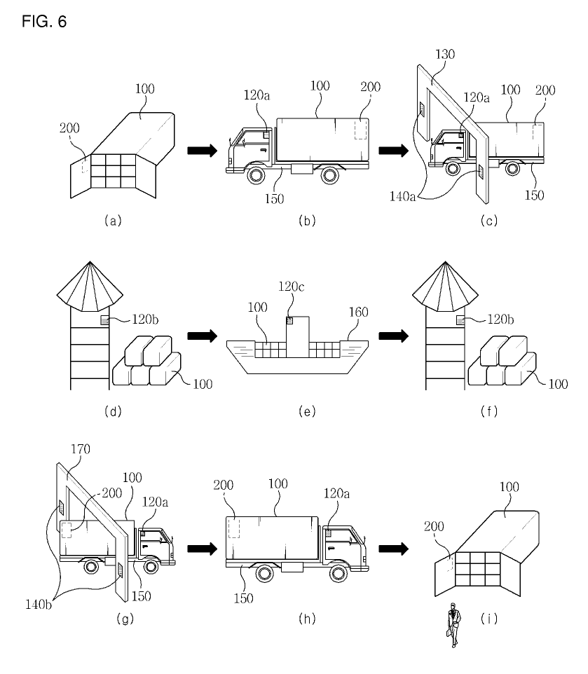

FIG. 4 is a flowchart illustrating a process of controlling a network configuration for a moving object according to an embodiment of the present invention, FIG. 5 is a flowchart illustrating an operation of controlling a dynamic network configuration for a moving object, illustrated in FIG. 4, in more detail, and FIG. 6 illustrates a transportation flow of a moving object based on control of a network configuration for a moving object according to an embodiment of the present invention.

Referring to FIGS. 1 through 6, when a monitoring device power-on signal is received from an external device, the controller 205 is provided with power and activated in step S301 and constructs a 1:1 network with an Internet gateway 120a mounted in a vehicle 150 for transporting the container 100 in step S302 in order to transmit monitoring information on the container 100 to the information storage server 400 through the communication unit 204 and the Internet gateway 120a.

Here, the 1:1 network is constructed only by connecting the monitoring device 200 to the Internet gateway 120a mounted in the vehicle 150, and thus a relatively simple communication protocol is employed, transmission/reception of a signaling message for maintaining the network configuration and processing of the signaling message are easily performed and a signaling message transmitting/receiving period increases as compared to the case of constructing a dynamic/static network. FIGS. 6(a) and 6(b) illustrate the construction of the 1:1 network. Steps S301 and S302 represent overland transportation before the vehicle 120 enters a container terminal.

When the controller 205 receives the first gate passing signal that represents that the container 100 enters the container terminal through a first gate 130 from the short-distance communication tag 201 in step S303, the controller 205 activates the operation sensor 202 in step S304. Step S303 represents that the container 100 passes through the first gate 130 and thus the overland transportation of the container 100 is finished, which is illustrated in FIG. 6(c). In FIG. 6(c), a reader 140a may be attached to the first gate 130. The reader 140a may be an RF reader or an RSU of DSRC according to the type of the short-distance communication tag 201 attached to the vehicle 150.

When the controller 205 receives a signal that represents the movement of the container 100 from the operation sensor 202 in step S305, the controller 205 controls the communication unit 204 to disconnect the container 100 from the 1:1 network, which is connected with the Internet gateway 120a of the vehicle 150 in step S302, in step S306.

In step S307, the controller 205 connects/disconnects the container 100 to/from a dynamic network before a departure signal is received from an external device in step S308. This is explained in detail with reference to FIG. 5.

When the controller 205 receives a signal representing that the movement of the container 100 is stopped from the operation sensor 202 in step S330 in FIG. 5, the controller 205 connects the container 100 to a network composed of a plurality of monitoring devices to construct a dynamic network with the monitoring devices in step S331.

When the controller 205 receives a network reconstruction signal from an Internet gateway 120b mounted in a lighting tower of a container terminal in step S332, the controller 205 disconnects the container 100 from the dynamic network and returns to step S331 to reconstruct a dynamic network. Here, the dynamic network is reconstructed in order to optimize the network because the container 100 is unloaded in a stack form in the container terminal. Furthermore, since it is difficult for the controller 205 to confirm completion of unloading of the container 100, that is, the standard of determining a network optimization time is not definite, the controller 205 reconstructs an optimized network when receiving the network reconstruction signal from the Internet gateway 120b mounted in facilities such as the lighting tower of the container terminal.

On the contrary, when the controller 205 does not receive the network reconstruction signal in step S332, the controller 205 confirms whether a signal representing the movement of the container 100 is transmitted from the operation sensor 202 in step S334. The controller 205 progresses to step S335 when confirming that the signal representing the movement of the container 100 is transmitted from the operation sensor 202 in step S334 and returns to step S332 when the controller 205 confirms that the signal representing the movement of the container 100 is not transmitted from the operation sensor 202 in step S334.

In step S335, the controller 205 controls the communication unit 204 to disconnect the container 100 from the dynamic network to which the container 100 is connected in step S331 and then progresses to step S308 of FIG. 4. The process illustrated in FIG. 5 explains construction of a network before the container 100 entering the container terminal is loaded in a ship 160 and departed. Since the container 100 may be frequently moved before loaded in the ship 160, the dynamic network more efficient for a network configuration is constructed.

When the controller 205 receives a departure signal from an Internet gateway 120c set in a control center of the ship 160 loading containers in step S308, the controller inactivates the activated operation sensor 202 in step S309. Here, the operation sensor 202 is inactivated because the shipped container 100 is hardly moved until the container 100 is unloaded from the ship 160.

When the controller 205 does not receive the departure signal from the Internet gateway 120c set in the control center of the ship 160 loading the containers for a predetermined period of time in step S308, the controller 205 returns to step S307 to repeat steps S330 through S335 of FIG. 5.

The controller 205 connects the container 100 to a static network composed of other monitoring devices in step S310. Since the container 100 is barely moved after loaded in the ship 160, there is a low possibility that the container 100 is disconnected from the current network and connected to a new network. Accordingly, it is desirable to continuously maintain the current network, and thus the controller 205 constructs the static network. Furthermore, the period of a signal transmitted/received to/from other containers increases when the network is constructed or in the constructed network after the container is shipped, and thus the static network which saves power as compared to a dynamic network is constructed. FIG. 6(e) illustrates the shipped container 100.

When the controller 205 receives a container unloading start signal from the Internet gateway 120c set in the control center of the ship 160 loading the containers in step S311, the controller 205 activates the operation sensor 202 in step S312. When the controller receives a signal representing the movement of the container 100 from the activated operation sensor 202 in step S313, the controller 205 disconnects the container 100 from the static network, to which the container 100 is connected in step S310, in step S314.

Subsequently, the controller 205 progresses to step S315. Step S315 is identical to step S307 so that explanation thereof is omitted. FIG. 6(f) illustrates that the container 100 is unloaded from the ship 160 to a container terminal. The container 100 may be moved multiple times until the container 100 unloaded from the ship 160 to the container terminal exits a second gate 170, and thus a dynamic network more efficient for a network configuration is constructed.

When the controller 205 receives a second gate passing signal representing that the container 100 exits the container terminal through the second gate 170 from the short-distance communication tag 201 in step S316, the controller 205 inactivates the operation sensor 202 in step S317. Then, the controller 205 constructs a 1:1 network with the Internet gateway 120a mounted in the vehicle 150 transporting the container 100 in step S318. Here, step S316 represents overland transportation of the container 100 passing through the second gate 170, which is illustrated in FIGS. 6(g) and 6(h). FIG. 6(i) illustrates that the container 100 arrives at a destination and a recipient unloads the goods from the container 100.

When the controller 205 does not receive the second gate passing signal representing that the container 100 exits the container terminal from the short-distance communication tag 201 for a predetermined period of time in step S316, the controller 205 returns to step S315 and repeats steps S330 through S335 of FIG. 5.

Finally, when the controller 205 receives a monitoring device power off signal from an external device in step S319, the aforementioned operations are finished.

While the operation of receiving the departure signal in step S308 and the operation of receiving the unloading start signal in step S311 are respectively performed once in the current embodiment of the present invention, the present invention is not limited thereto and the operations may be repeatedly carried out when there are multiple container terminals for shipping containers and multiple container terminals for unloading the shipped containers.

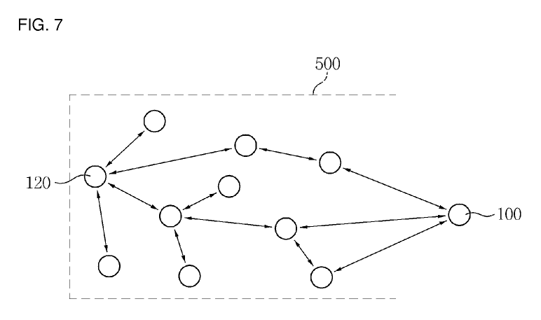

FIG. 7 illustrates a dynamic/static network configuration model for moving objects according to an embodiment of the present invention.

Referring to FIGS. 6 and 7, while the container 100 constructs a multi-hop ad-hoc network with other containers, the present invention is not limited thereto and can be applied to models of various types such as star-topology, peer to peer topology, etc. In FIG. 7, reference numeral 500 represents a previously constructed network and 120 denotes an Internet gateway corresponding to a sink node of the network. The Internet gateway 120 may be the Internet gateway 120b set in facilities such as the lighting tower of the container terminal, as illustrated in FIG. 6(d), or the Internet gateway 120c set in the control center of the ship, 160 as illustrated in FIG. 6(e). Reference numeral 100 denotes a container that is to be connected to the previously constructed network 500 or disconnected from the network.

The operation sensor 202 allows a disconnection message to be actively sent to neighboring containers or the Internet gateways 120b and 120c without waiting for a time-out for waiting for the signaling message when the container 100 is connected to a network after stopped and when the container 100 connected to a network is moved to increase network configuration efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for controlling a network configuration for moving objects, comprising:
a plurality of moving objects transported by a specific transportation means; and
a monitoring device which includes a short-distance communication tag and an operation sensor, is attached to a moving object to construct a network with the transportation means transporting the moving object overland and constructs a network with other monitoring devices attached to other moving objects according to whether the other moving objects are moved when the moving object is not being transported overland.

2. A monitoring device for controlling a network configuration for a moving object, comprising:
a communication unit communicating with an Internet gateway;
an operation sensor sensing whether the moving object is moved;
a short-distance communication tag sensing whether the moving object passes through a first point or a second point; and
a controller constructing a network with a first transportation means transporting the moving object overland and constructing a network with other monitoring devices attached to multiple other moving objects according to whether the moving object is moved when the moving object is not being transported overland.

3. The monitoring device of claim 2, wherein the controller constructs a 1:1 network with the first transportation means, activates the operation sensor when a signal representing that the moving object passes through the first point is received from the short-distance communication tag and disconnects the moving object from the 1:1 network when the operation sensor senses the movement of the moving object.

4. The monitoring device of claim 3, wherein the controller connects the moving object o a dynamic network composed of multiple other moving objects when the moving object is unloaded and the operation sensor senses that the movement of the moving object is stopped.

5. The monitoring device of claim 4, wherein, after the moving object is unloaded and connected to the dynamic network, the controller disconnects the moving object from the dynamic network and connects the moving object to a new dynamic network when a dynamic network reconstruction signal is received from an external device through the communication unit.

6. The monitoring device of claim 4,
wherein the controller disconnects the moving object from the dynamic network when the operation sensor senses the movement of the moving object after the moving object is connected to the dynamic network, repeats connection/disconnection of the moving object to/from a dynamic network until a departure signal is received from an external device through the communication unit, inactivates the operation sensor and connects the moving object to a static network composed of multiple other monitoring devices when the departure signal is received.

7. The monitoring device of claim 6, wherein the controller activates the operation sensor when an unloading start signal is received from an external device through the communication unit after the moving object is connected to the static network, disconnects the moving object from the static network when the operation sensor senses the movement of the moving object, and connects the moving object to a dynamic network composed of multiple other monitoring devices when the operation sensor senses that the moving object is stopped.

8. The monitoring device of claim 7, wherein the controller disconnects the moving object from the dynamic network when the movement of the moving object is sensed after the moving object is connected to the dynamic network, repeats connection/disconnection of the moving object to/from a dynamic network until the moving object passes through the second point, inactivates the operation sensor and then constructs a 1:1 network with the first transportation means when a signal representing that the moving object passes through the second point is received.

9. The monitoring device of claim 4, wherein the controller disconnects the moving object from the dynamic network when the operation sensor senses the movement of the moving object after the moving object is connected to the dynamic network, repeats connection/disconnection of the moving object to/from a dynamic network until a departure signal is received from an external device through the communication unit, inactivates the operation sensor and connects the moving object to a static network composed of multiple other monitoring devices when the departure signal is received.

10. The monitoring device of claim 9, wherein the controller activates the operation sensor when an unloading start signal is received from an external device through the communication unit after the moving object is connected to the static network, disconnects the moving object from the static network when the operation sensor senses the movement of the moving object, and connects the moving object to a dynamic network composed of multiple other monitoring devices when the operation sensor senses that the moving object is stopped.

11. The monitoring device of claim 10, wherein the controller disconnects the moving object from the dynamic network when the movement of the moving object is sensed after the moving object is connected to the dynamic network, repeats connection/disconnection of the moving object to/from a dynamic network until the moving object passes through the second point, inactivates the operation sensor and then constructs a 1:1 network with the first transportation means when a signal representing that the moving object passes through the second point is received.

12. The monitoring device of claim 2, wherein the operation sensor senses an impact applied to the moving object and provides information on the impact to the controller in order to confirm whether the moving object is damaged.

13. The monitoring device of claim 12, further comprising a storage unit storing the information on the impact applied to the moving object, provided by the operation sensor.

14. The system of claim 1, further comprising a state sensor sensing monitoring information on the moving object.

15. A method for controlling a network configuration for a moving object, comprising:
a first network constructing step in which a monitoring device attached to the moving object constructs a 1:1 network with a first transportation means for transporting the moving object overland;
a second network constructing step in which the monitoring device disconnects the moving object from the 1:1 network when the movement of the moving object is detected after the moving object passes through a first point and connects the moving object to a dynamic network composed of multiple other moving objects when it is detected that the movement of the moving object is stopped;
a third network constructing step in which the monitoring device disconnects the moving object from the dynamic network when the movement of the moving object is detected and connects the moving object to a static network composed of multiple other monitoring devices when a departure signal is received from an external device;
a fourth network constructing step in which the monitoring device disconnects the moving object from the static network when an unloading start signal is received from an external device and the movement of the moving object is detected and connects the moving object to a dynamic network composed of multiple other monitoring devices when it is detected that the movement of the moving object is stopped; and
a fifth network constructing step in which the monitoring device disconnects the moving object from the dynamic network when detecting the movement of the moving object and constructs a 1:1 network with the first transportation means when it is detected that the moving object passes through a second point.

16. The method of claim 15, wherein the second network constructing step comprises a step in which the monitoring device activates an operation sensor which senses the movement of the moving object when it is detected that the moving object passes through the first point and senses an impact applied to the moving object in order to confirm whether the moving object is damaged.

17. The method of claim 15, further comprising a step in which the monitoring device disconnects the moving object from the dynamic network and connects the moving object to a new dynamic network when a dynamic network reconstruction signal is received from an external device after the moving object is unloaded, stopped and connected to the dynamic network after the second or fourth network constructing step.

18. The method of claim 17, wherein, in the third network constructing step, the monitoring device disconnects the moving object from the dynamic network when the movement of the moving object is sensed after the moving object is unloaded, stopped and connected to the dynamic network, repeats connection/disconnection of the moving object to/from a dynamic network until the departure signal is received, and inactivates the activated operation sensor when the departure signal is received.

19. The method of claim 18, wherein, in the fourth network constructing step, the monitoring device activates the inactivated operation sensor when the unloading start signal is received from the external device.

20. The method of claim 19, wherein, in the fifth network constructing step, the monitoring device disconnects the moving object from the dynamic network constructed when the moving object loaded in the first transportation means is unloaded from the first transportation means, repeats connection/disconnection of the moving object to/from a dynamic network until the moving object passes through the second point, and inactivates the activated operation sensor when it is detected that the moving object passes through the second point.

21. The method of claim 15, further comprising a step of activating a state sensor sensing monitoring information on the moving object when the monitoring device is activated before the first network constructing step.
